(19) United States
(12) Patent Application Publication
(10) Pub. No.: US 2022/0039603 A1
(43) Pub. Date: Feb. 10, 2022

(54) APPARATUS FOR PREPARING CUSTOM RECIPES

(71) Applicant: Lanisha Rancy, Copperas Cove, TX (US)

(72) Inventor: Lanisha Rancy, Copperas Cove, TX (US)

(21) Appl. No.: 17/396,665

(22) Filed: Aug. 7, 2021

Related U.S. Application Data
(60) Provisional application No. 63/063,398, filed on Aug. 9, 2020.

(51) Int. Cl. A47J 44/00; A47J 37/06

(52) U.S. Cl. CPC A47J 44/00; A47J 37/0676

(57) ABSTRACT

An apparatus for creating custom recipes is disclosed. The apparatus may comprise a body that may hold cartridges having flavouring agents and a cooking chamber connected to the cartridges via a plurality of valves. The apparatus may be controlled by a microcontroller. The apparatus may receive custom formulas for creating custom recipes from users. Upon receiving the formula, the apparatus may determine the quantities of flavouring agents that are to be added from each cartridges and the mode of cooking to create the custom recipe. The apparatus may constantly communicate with the client devices, so that user can monitor real time status of cooking, level of cartridges and so on.

### CROSS-REFERENCE TO RELATED APPLICATIONS

This application claims the benefit of U.S. Provisional Patent Application Ser. No. 63/063,398, entitled “Spice Oven”, filed on Aug. 9, 2020, which is incorporated herein in its entirety.

### TECHNICAL FIELD

The present disclosure is related to the field of kitchen appliances. More particularly, the present disclosure is related to a smart novel oven for preparing custom recipes.

### BACKGROUND

Kitchen appliances such as ovens have become a common part of kitchens around the world. An oven is a thermally insulated chamber used for the heating, baking, or drying of a substance, and most commonly used for cooking. Modern microwave ovens are used to cook food using microwave radiation rather than infrared radiation (typically a fire source). Conceptualized in 1946, Dr. Percy Spencer allegedly discovered the heating properties of microwaves while studying the magnetron. By 1947, the first commercial microwave was in use in Boston, Mass. Toaster ovens are small electric ovens with a front door, wire rack, and removable baking pan. To toast bread with a toaster oven, slices of bread are placed horizontally on the rack. When the toast is done, the toaster turns off, but in most cases, the door must be opened manually. Most toaster ovens are significantly larger than toasters but are capable of performing most of the functions of electric ovens, albeit on a much smaller scale.

Microwave ovens are a common kitchen appliance and are popular for reheating previously cooked foods and cooking a variety of foods such as cakes, pizza, and so on. They rapidly heat foods that can easily burn or turn lumpy if cooked in conventional pans, such as hot butter, fats, or chocolate. Microwave ovens usually do not directly brown or caramelize food, except when the oven is used to heat frying oil and other oily items, which attain a far higher temperature than that of boiling water. When electromagnetic radiations in the microwave frequency range are exposed to food, polar molecules in the food start to rotate and produce thermal energy, known as dielectric heating. This is the basic principle of a microwave oven.

Modern ovens are typically fuelled by either natural gas or electricity, with bottle gas models available but not common. When an oven is contained in a complete stove, the fuel used for the oven may be the same as or different from the fuel used for the burners on top of the stove. Ovens usually can use a variety of methods to cook. The most common may be to heat the oven from below. This is commonly used for baking and roasting. The oven may also be able to heat from the top to provide broiling/grilling. A fan-assisted oven that uses a small fan to circulate the air in the cooking chamber, can be used. Both are also known as convection ovens. An oven may also provide an integrated rotisserie.

Ovens also vary in the way that they are controlled. The simplest ovens (for example, the AGA cooker) may not have any controls at all; the ovens simply run continuously at various temperatures. More conventional ovens have a simple thermostat that turns the oven on and off and selects the temperature at which it will operate. Set to the highest setting, this may also enable the broiler element. A timer may allow the oven to be turned on and off automatically at pre-set times. More sophisticated ovens may have complex, computer-based controls allowing a wide variety of operating modes and special features including the use of a temperature probe to automatically shut the oven off when the food is completely cooked to the desired degree.

Conventional ovens are restricted to cook or bake the food item that is being kept in the cooking chamber of the oven for the pre-set time required for the user. The biggest disadvantage with such a system is that users may get bored of the same taste and recipes and they would have to take out the food and add seasonings or spices and again needed to cook the food in the oven. Moreover, this leads to lots of wastage of energy and time. Conventional ovens do not provide the option for such experiments thereby restricting the usage of microwave ovens.

The functionalities of ovens have been restricted to merely changing the properties of an item being cooked using different forms of thermal energy infusion. It will be advantageous to provide a modern oven that allows users to control the taste of the substance that is being cooked in addition to merely heating them. A modern oven that allows users to customize recipes and allows them to experiment with new flavours and tastes will be highly appreciated by cooking enthusiasts and food lovers. As such, there are no simple solutions, apparatuses, or methods that allow experimentalists to try their hand with food in a convenient manner while baking or cooking in an oven.

The present disclosure addresses the abovementioned technical deficiencies of conventional microwave ovens to provide a state-of-the-art solution for cooking enthusiasts to customize and use recipes according to their liking.

### SUMMARY

In light of the disadvantages mentioned in the previous section, the following summary is provided to facilitate an understanding of some of the innovative features unique to the present invention and is not intended to be a full description. A full appreciation of the various aspects of the invention can be gained by taking the entire specification and drawings as a whole.

Embodiments described herein disclose a smart cooking apparatus that may allow users to create customized recipes. The apparatus may comprise of a body that may allow one or more cartridges that have flavouring agents to be inserted into the body via one or more cartridge slots. The apparatus may hold a plurality of flavouring agents having different tastes at a time. Furthermore, the apparatus may allow users to communicate with the apparatus and provide instructions to it via a user interface. Herein, a microcontroller disposed within the body of the apparatus may be programmed to receive custom recipe formulas from the users. Users may provide pre-stored recipes in the user interface or custom recipes comprising the mode of cooking, cooking time, and specific ratios of certain flavouring agents that are to be mixed to create a new recipe. Upon receiving the inputs from users specifying the ratios of flavouring agents that are to be added from each of the one or more cartridges, the apparatus may determine the number of flavouring agents that may be added from each of the one or more cartridges. Upon determining the quantity, the apparatus may further dispense the determined quantities of flavouring agents via a plurality of flavour injectors based on the flavouring agent dispensing intervals, wherein the plurality of flavour injectors are connected to a plurality of valves.

Furthermore, the apparatus may calculate the amount of time required to extract the determined quantities of flavouring agents as well as the estimated completion of cooking time. Further, the apparatus may activate valve actuators that connect the cooking chamber to one or more cartridges and the flavours are dispensed to the cooking food item that is being cooked in the cooking chamber. Based on the calculations, the apparatus may open the connections between the valves and the cooking chamber via a plurality of valve actuators. The apparatus may open the plurality of valves for the calculated amount of time thereby allowing to draw out/extract the determined quantities of flavouring agents from each of the one or more cartridges into the cooking chamber for generating the custom recipe according to the formula provided by the user.

This summary is provided merely for purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

The abovementioned embodiments and further variations of the proposed invention are discussed further in the detailed description.

### BRIEF DESCRIPTION OF THE DRAWINGS

FIG. 1 is a block diagram of the architecture of a recipe management system according to the embodiments of the present disclosure;

FIG. 2 is a block diagram of the architecture of a recipe management device communicatively connected to the recipe management system according to the embodiments of the present disclosure;

FIG. 3 is a perspective view of an exemplary cooking oven for creating custom recipes according to the embodiments of the present disclosure;

FIG. 4 is an exemplary view depicting the control panel and cartridge box of the apparatus for creating custom recipes according to the embodiments of the present disclosure;

FIG. 5 is a perspective top view of an exemplary apparatus for creating custom recipes according to the embodiments of the present disclosure;

FIG. 6 is an exemplary view depicting the top lid and exhausts for creating custom recipes according to the embodiments of the present disclosure;

FIG. 7 is an exemplary view depicting the self-cleaning dump box of an exemplary apparatus creating custom recipes according to the embodiments of the present disclosure;

FIG. 8 is a perspective front view depicting the front lid of an exemplary apparatus creating custom recipes according to the embodiments of the present disclosure;

FIG. 9 is a perspective view depicting the dump box of an exemplary apparatus creating custom recipes according to the embodiments of the present disclosure;

FIG. 10 is a perspective view of an exemplary cooking oven creating custom recipes according to the embodiments of the present disclosure;

FIG. 11 is a perspective view of an exemplary apparatus injecting seasonings or spices to the item being cooked according to the embodiments of the present disclosure;

FIG. 12 is a perspective view of an exemplary apparatus (cartridge) storing the seasonings or spices according to the embodiments of the present disclosure;

The drawings described herein are for illustration purposes only and are not intended to limit the scope of the present subject matter in any way.

### DETAILED DESCRIPTION

In the following description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limited sense, and the scope of the present invention is defined only by the appended claims.

The specification may refer to “an”, “one” or “some” embodiment(s) in several locations. This does not necessarily imply that each such reference is to the same embodiment(s), or that the feature only applies to a single embodiment. A single feature of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments described herein discloses an apparatus and a method for creating custom recipes in microwave ovens. The primary components of the apparatus include a body, a plurality of refill cartridges, a plurality of injectors, a cooking chamber, a ventilation area, a magnetron assembly, a transformer, a microcontroller, a display, and a door. In addition to the above, there are several other secondary components that support the primary components to allow the smooth functioning of the apparatus.

The apparatus allows users to create custom recipes by instructing the apparatus to inject one or more flavouring agents in a user-defined ratio. Herein, the user may select one or more flavouring agents from the available list of cartridges and assign a specific ratio in which the selected flavouring agents are to be mixed. The combination of flavouring agents and the ratio defined by the user will be referred to as a ‘custom formula’ throughout this disclosure. The custom formula may be communicated to the microcontroller that is provided within the apparatus. The microcontroller herein is configured to control various functionalities of the apparatus including receiving user instructions, receiving the custom formula, managing the user interface, managing the cooking process, dispensing the flavouring agents, and the like.

One or cartridges may be fixed into the apparatus for the purpose of mixing and creating custom recipes. Herein, the flavouring agents may comprise flavours, such as cheese, cream, pepper powder, any kind of seasonings or spices, and the like. The flavouring agents may be stored in small containers, referred as cartridges throughout this document. The cartridges may be fixed into the apparatus inside the slots provided for holding them. The apparatus keeps track of the total number of cartridges that are fixed into the apparatus at any given time. The apparatus further keeps track of the flavour assigned to each of the recipes and the amount of flavours remaining in each of the cartridges. At any given time, the apparatus may be aware of the current status of cartridges including the total number of cartridges available, flavours of each refill, and the remaining content in each refill. The microcontroller and a plurality of sensors disposed within the apparatus help the apparatus in keeping track of the abovementioned details. Furthermore, such data are stored in a memory that is coupled to the microcontroller.

It may be noted that the terms “Spices Oven”, “Microwave oven” and “Oven” may use interchangeably throughout this document as per the context of the sentence. The terms “flavouring agents”, “flavours”, and “toppings” may be used interchangeably throughout this document. The terms “cartridges” or “refills” may be used interchangeably throughout this document. The terms used herein do not restrict the scope of the present disclosure.

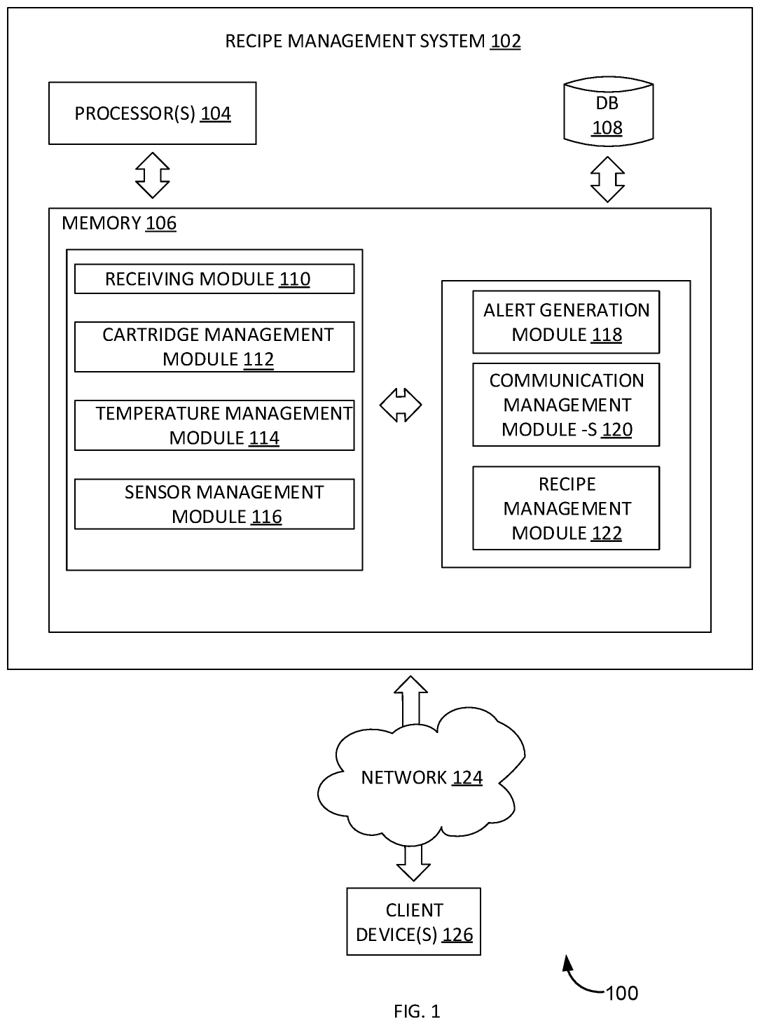

Before moving to the subsequent sections of this disclosure that describes the working of the apparatus in detail, it is pertinent to refer to the various numbering provided in the drawings. Referring to the drawings, FIG. 1 is a block diagram 100 of the architecture of a recipe management system 102 connected to one or more client devices 126 via a network 124. As shown in FIG. 1, the recipe management system 102 may include a processor(s) 104 and memory 106 that are communicatively coupled to each other. Further, the personnel evaluation system 102 may include a database (DB) 108 that may be communicatively connected to the memory 106. Furthermore, as shown in FIG. 1, memory 106 may include a receiving module 110, a cartridge management module 112, a temperature management module 114, a sensor management module 116, an alert generation module 118, a communication management module-s 120, and a recipe management module 122. One or more client devices 126 may be communicatively connected to the recipe management system 102. Components of the recipe management system 102 may be any combination of hardware and programming to implement the functionalities described herein. In some implementations, the programming may be processor 104 executable instructions stored on a non-transitory machine-readable storage medium (e.g., memory 106), and the hardware may include at least one processing resource to retrieve and/or execute those instructions. Processor(s) 104 may include, but are not limited to, one or more digital signal processors (DSPs), one or more microprocessors, one or more special-purpose computer chips, one or more field-programmable gate arrays (FPGAs), one or more application-specific integrated circuits (ASICs), one or more computer(s), various analog to digital converters, digital to analog converters, and/or other support circuits. Processor(s) 104 thus may also include the functionality to encode messages and/or data or information. Processor(s) 104 may include, among other things, a clock, an arithmetic logic unit (ALU), and logic gates configured to support the operation of processor(s) 104. Further, the processor(s) 104 may include functionality to execute one or more software programs, which may be stored in the memory 106 or otherwise accessible to the processor(s) 104.

Memory 106, may store any number of pieces of information, and data, used by the system to implement the functions of the system. Memory 106 may include, for example, volatile memory and/or non-volatile memory. Examples of volatile memory may include but are not limited to volatile random-access memory (RAM). The non-volatile memory may additionally or alternatively comprise an electrically erasable programmable read-only memory (EEPROM), flash memory, hard drive, and the like. Some examples of volatile memory include, but are not limited to, dynamic RAM, static RAM, and the like. Some example of the non-volatile memory includes, but are not limited to, hard disks, magnetic tapes, optical disks, programmable read-only memory, erasable programmable read-only memory, electrically erasable programmable read-only memory, flash memory, and the like. Memory 106 may be configured to store information, data, applications, instructions, or the like for enabling the system to carry out various functions in accordance with various example embodiments. Additionally, or alternatively, memory 106 may be configured to store instructions which when executed by processor(s) 104 cause the recipe management system 102 to behave in a manner as described in various embodiments.

In one implementation, network 124 may be a wireless network, a wired network, or a combination thereof. Network 124 may be implemented as one of the several types of networks, such as an intranet, local area network (LAN), wide area network (WAN), the internet, and the like. Network 124 may either be a dedicated network or a shared network. The shared network represents an association of the several types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, network 124 may include a variety of network devices, including routers, bridges, servers, computing devices, storage devices, and the like.

During the operation, the receiving module 110 may receive data from the client devices 126. Data may include a set of pre-stored recipes or any custom recipes that are added by the user with the user interface of the client device 126, data from the plurality of sensors, input provided by the user of the client device 126, and the like. The cartridge management module 112 may process the recipes received from the client device 126 to determine which flavouring agents are to be used. The recipes may be added by the user in the user interface of the client device 126 or pre-stored recipes that are available in the client device 126. The recipes received from the client device 126 may include the cooking time, cooking temperature, set of ingredients used in the cooking, and the like. The cartridge management module 112 processes these recipes in real-time and determines information including the flavouring agents and the interval for dispensing the flavouring agents. One or more flavouring agents may be stored in a cartridge array at the top of the oven that can be refilled or changed whenever necessary.

The temperature management module 114 processes the required temperature needed for cooking a specific recipe. The user may adjust the required temperature by using the client device 126 or with the help of controls in the oven. The received data are synchronized with the recipe received from the client device 126 to determine one or more information. The cartridge management module 112 and the temperature management module 114 work along with the sensor management module 116 to identify useful information in real-time. While the sensor management module 116 may process the recipe or the data given by the user with the user interface of the client device for the identification of useful information, it also continues to learn from the data that is being gathered currently. The alert generation module 118 and the recipe management module 122 may be responsible for determining the recipes and alerting the user regarding the same. The communication module-s 120 may be responsible for managing all the communication between the apparatus and client devices 126.

Furthermore, some functional errors may occur sometimes depending on the working condition of the oven. An adverse event may include events such as missing some particular seasoning or topping in the array of cartridges, an empty cartridge, power loss, network issues, and the like. Herein, the recipe management system 102, processes the received input by the user from the user interface of the client device 126 to determine the adverse event. Clues received from the primary alert events such as missing or empty cartridges and the like are cross-checked with the different modules in the system to determine possible reasons for the adverse event and informs the alert generation module 118. Upon determining an adverse event, the recipe management system 102 transmits a communication to client devices 126.

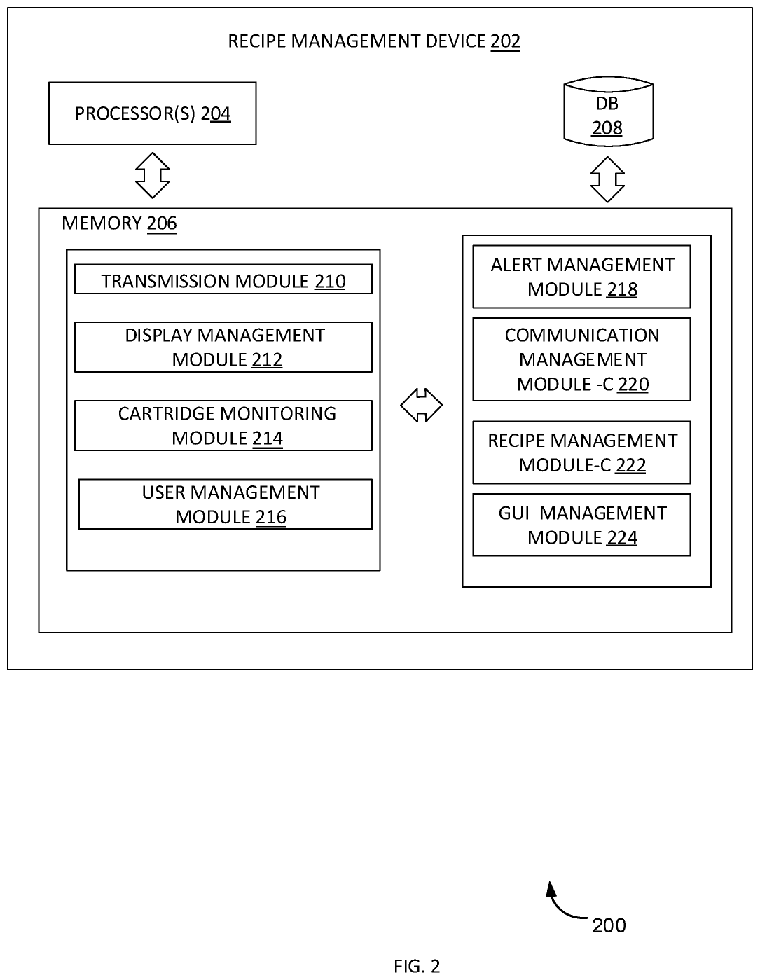

FIG. 2 is a block diagram 200 of the architecture of the recipe management device 202 communicatively connected to the recipe management system 102. The recipe management device 202 corresponds to one of the client devices 126 of FIG. 1. The recipe management device 202 may also comprise a processor(s) 204 communicatively connected to a memory 206 and a database 208. Memory 206 may include a transmission module 210, a display management module 212, a cartridge monitoring module 214, a user management module 216, an alert management module 218, a communication management module-c 220, a recipe management module-c 222, and a Graphical User Interface (GUI) management module 224.

During operation, the transmission module 210 may transmit recipes, information about flavouring agents, and other data required for a proper cooking condition, and other inputs generated by the user in the recipe management device 202 to the recipe management system 102. All communication to and from the device is managed by the communication management module-c 220. The display management module 212 manages the display unit of the recipe management device 202. The display unit may comprise a screen capable of displaying images and/or video feeds to the user. The GUI management module 224 may assist the user in providing inputs to the display unit. The recipe management module-c 222 may be capable of allowing users to create new recipes or download recipes from the internet or other supporting platforms. The recipe management module-c 222 allows users to activate a pre-uploaded recipe stored in the apparatus or upload new recipes to the apparatus. The user management module 216 manages the user profiles and allows users to customize their preferences. The alert management module 218 sends different alerts to the display unit such as cooking status, cartridge status received from the cartridge monitoring module 214, and the like.

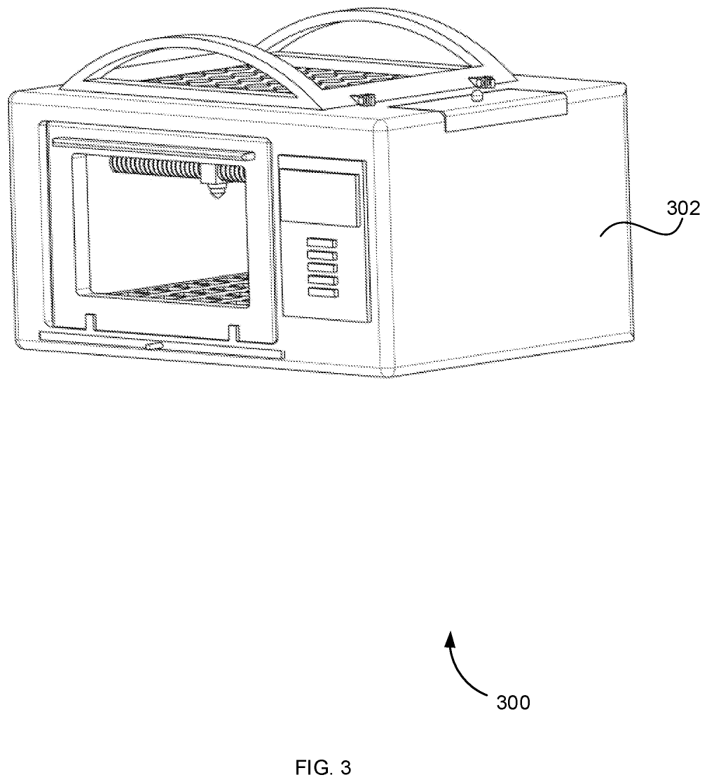

FIG. 3 is a perspective view 300 of an exemplary cooking oven for creating custom recipes according to the embodiments of the present disclosure. FIG. 3 depicts a microwave oven 302 that can inject flavours to the items that are being cooked in the cooking chamber of the oven by receiving data from the user. The cartridges are stored in a compartment provided at top of the oven 302 and the cartridges are managed by the microcontroller assembly. The flavouring agents stored in cartridges are injected into the food items through one or more injectors that may be managed and controlled by valve actuators. The oven 302 comprises all the basic components that a conventional cooking oven has, such as magnetron assembly, cooling fan, high voltage transformers, and the like. The different cooking modes of microwave oven 302 include microwave mode, convection mode, and grilling mode.

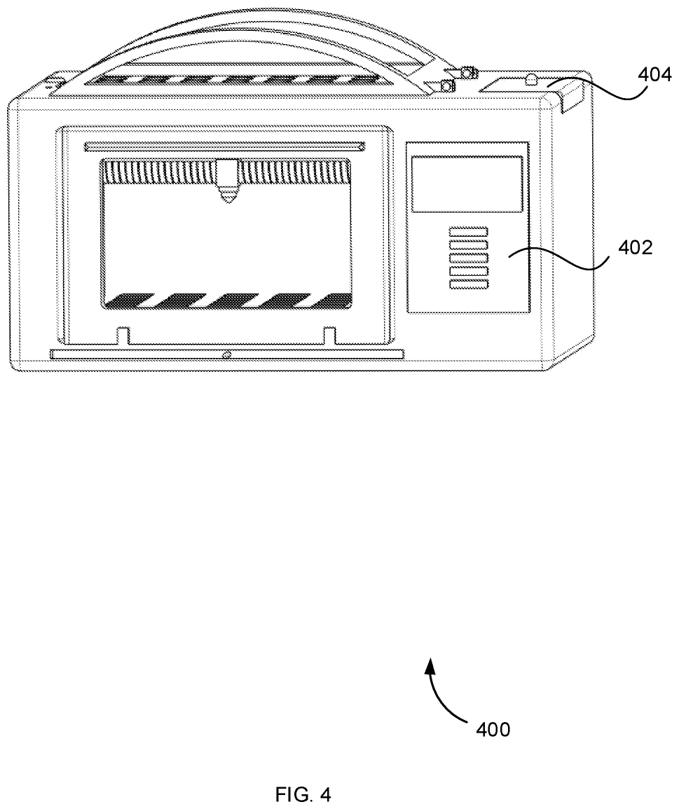

FIG. 4 is an exemplary view 400 depicting the control panel and cartridge array of the apparatus for creating custom recipes according to the embodiments of the present disclosure. The control panel 402 may be a touch screen used to give instructions directly to the microwave oven 302. The information, such as estimated cooking time, mode of cooking, details regarding the flavouring agents, pre-set temperature, and the like may be available from the control panel 402. The cartridge storage compartment 404 may be used to store the flavouring agents. One or more cartridges filled with flavouring agents may be inserted into one or more slots provided. The flavouring agents include ingredients used in cooking including condiments, spices, sauces, oils, and all other flavouring agents. The details regarding the cartridges may be added to the user interface of the mobile application. The microcontroller constantly communicates with the mobile application, so that the real-time status of the cartridges may be available in the user interface. Moreover, the user can directly purchase the cartridges or flavouring agents from the mobile application whenever he/she wanted to refill the cartridges or a new taste is necessary. The cooking chamber may be connected to one or more cartridges via a plurality of valves. The valves are controlled by the microcontroller by receiving information from the user. The microcontroller receives input from the user specifying the recipe to be cooked by the microwave oven 302. The further details include cooking temperature, cooking mode, and cooking time for the recipes that are to be cooked. In addition, the ratios of flavouring agents that are to be added from each of the one or more cartridges based on the recipe and intervals for dispensing flavouring agents are also determined by the user. The determined quantities of flavouring agents are dispensed via a plurality of flavour injectors based on the user's recipe. The flavour injectors are connected to one or more valves and valve actuators.

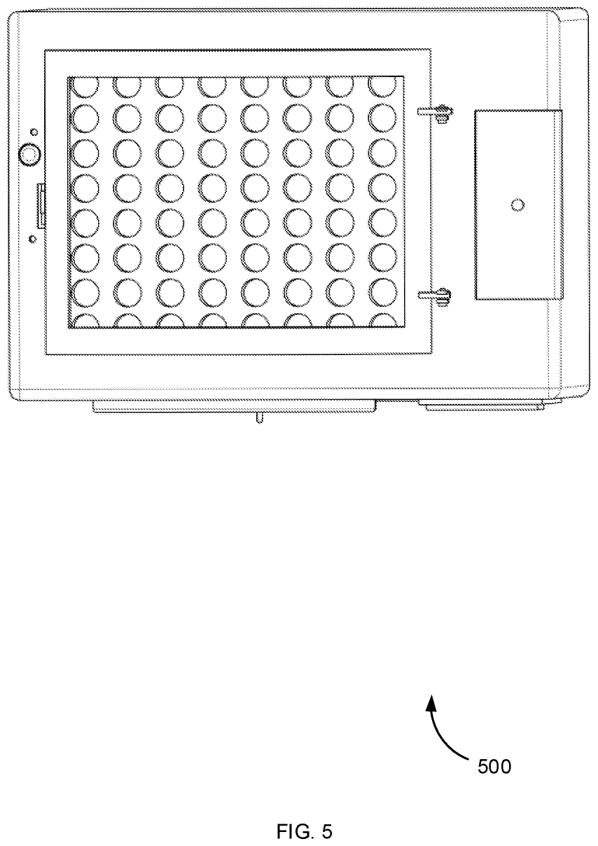

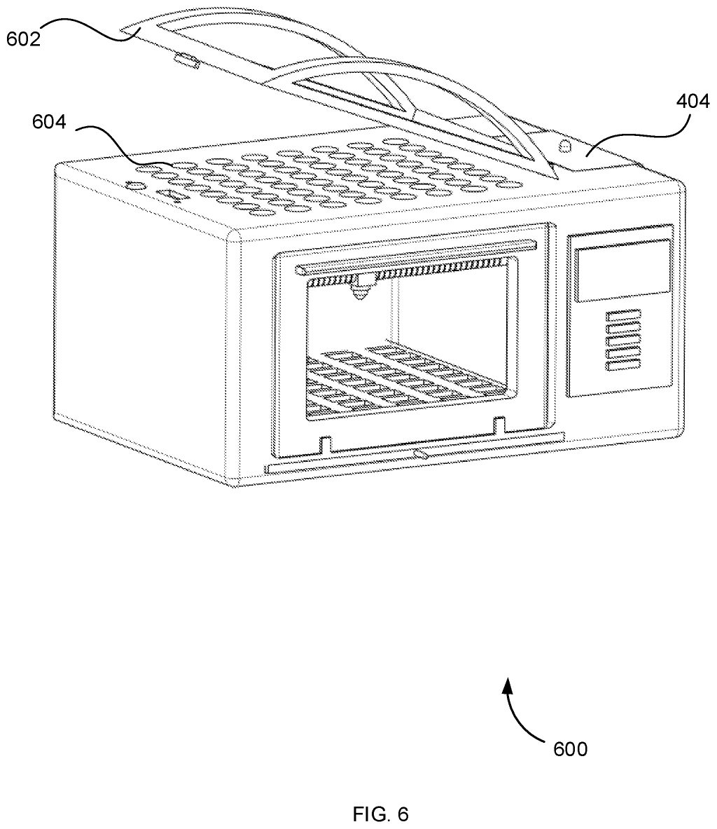

FIG. 5 is a perspective top view 500 of an exemplary apparatus for creating custom recipes according to the embodiments of the present disclosure. The cartridge storage array 404 can be accessed from the top of the apparatus by removing the lid. FIG. 6 is an exemplary view 600 depicting the top lid and exhausts for creating custom recipes according to the embodiments of the present disclosure. The top lid 602 may be made of a transparent material like glass which covers the exhaust steam coming out through the exhausts 604 while cooking. The exhausts 604 are directly connected to the cooking chamber and the steam generated while cooking moves to the exhaust area and are covered by a top lid 602.

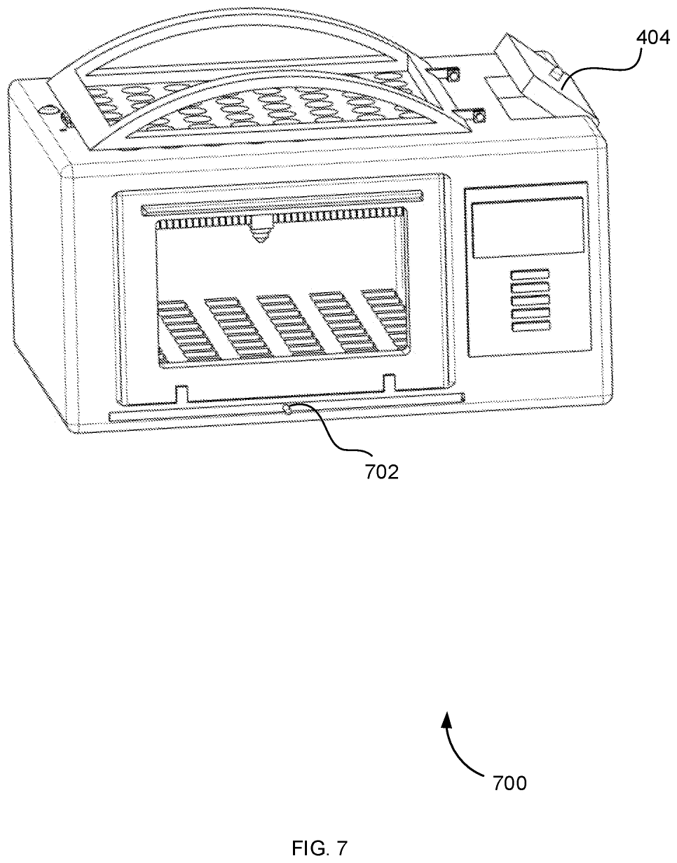

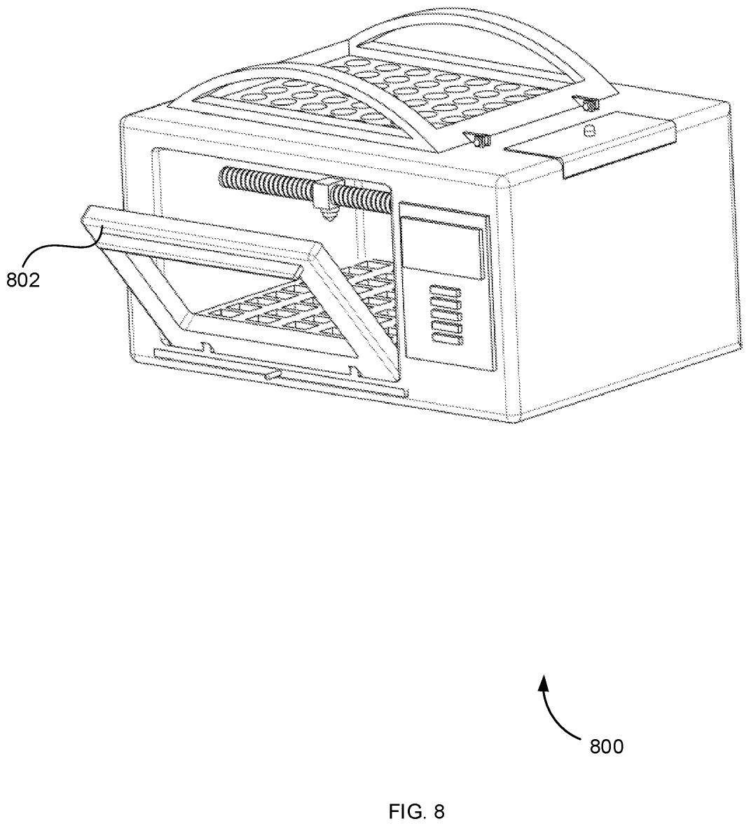

FIG. 7 is an exemplary view 700 depicting the self-cleaning dump box of an exemplary apparatus creating custom recipes according to the embodiments of the present disclosure. The oven 302 may be designed as such it cleans the residues of cooking by itself. To illustrate, the bottom portion of the cooking chamber is a removable mesh-type design. So any residues of food items that are being fallen out of the cooking plate may be collected in the dump box 702 provided at the bottom of the oven. The dump box 702 may be removed by simply pulling it out and re-inserted after cleaning. FIG. 8 is a perspective front view 800 depicting the front lid of an exemplary apparatus creating custom recipes according to the embodiments of the present disclosure. The front lid 802 covers the cooking chamber of the apparatus and helps to prevent the leakage of heat while cooking. The center portion of front lid 802 may be transparent so that the process happening inside of the cooking chamber may be visible from the outside also. In addition, one or more LED lights may be given in the cooking chamber to enhance the aesthetic appeal as well as for the easiness of the user to insert and take out cooked items. The lights may be arranged as they may turn on once the front doors 802 are opened. Also, the user may turn on or off the LED lights with the control panel 402.

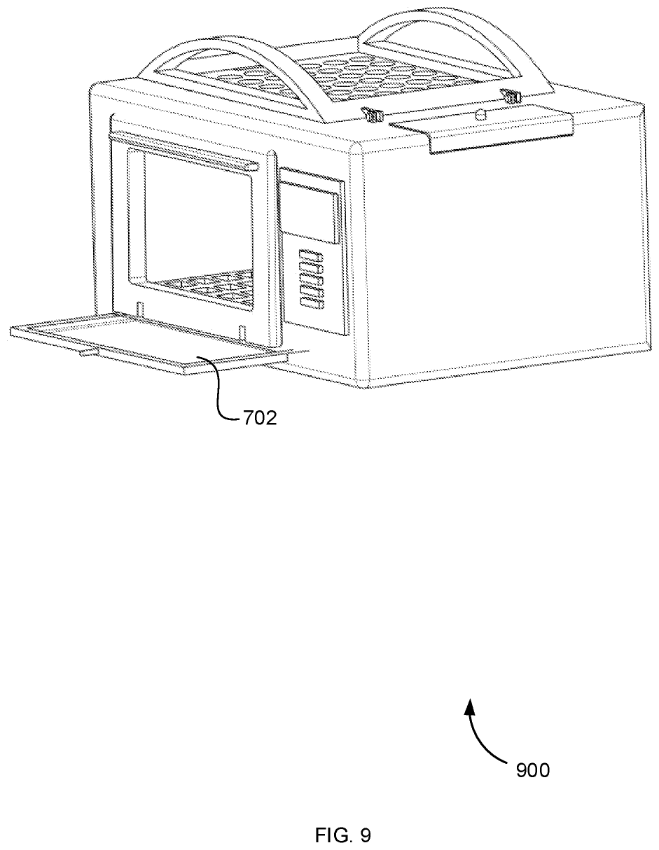

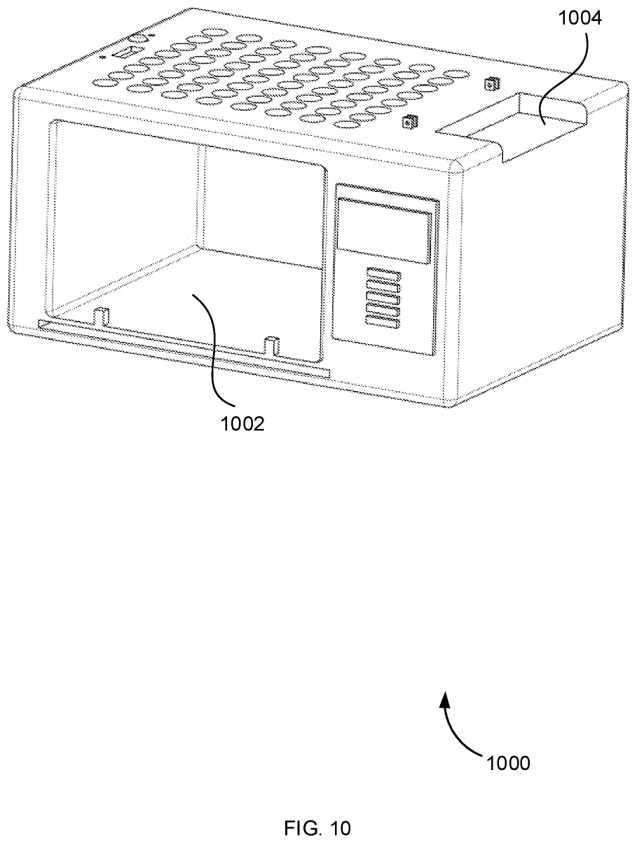

FIG. 9 is a perspective view 900 depicting the dump box 702 of an exemplary apparatus creating custom recipes according to the embodiments of the present disclosure. The dump box 702 is pulled out for cleaning purposes when the cooking is completed. The dump box 702 may be made of any material that is resistant to high temperature, since the operating temperature of the oven 302 may be high. The dump box 702 accomplishes the self-cleaning property of oven 302. FIG. 10 is a perspective view 1000 of an exemplary cooking oven creating custom recipes according to the embodiments of the present disclosure. The cooking chamber 1002 is the area where the items are being cooked inside the oven 302. The cartridges are stored in slots 1004. There may be one or more slots 1004.

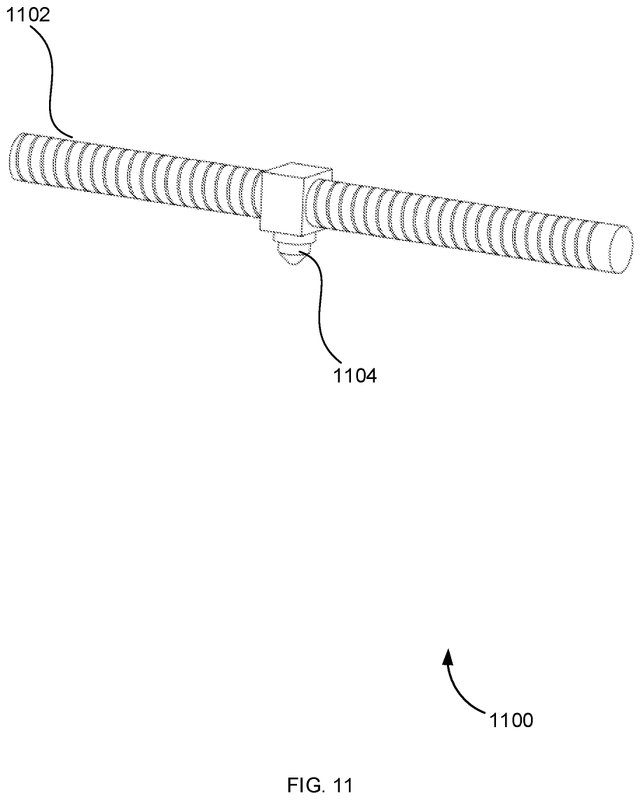

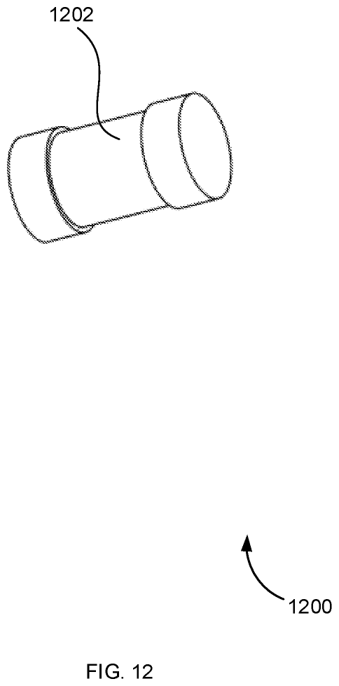

FIG. 11 is a perspective view 1100 of an exemplary apparatus injecting seasonings or spices to the item being cooked according to the embodiments of the present disclosure. The cooking chamber is connected to one or more cartridges via a plurality of valves 1102. The microcontroller controls the ratio of flavouring agents and the dispensing intervals according to the data collected from the user. The determined quantities of flavouring agents are dispensed via a plurality of flavour injectors 1104. One or more flavour injectors 1104 are connected to one or more valves 1102 and dispense the flavouring agents from the cartridges. The microcontroller monitors the real-time quantity and the level of flavouring agents remaining in each of the cartridges and alerts the user via the user interface. FIG. 12 is a perspective view 1200 of an exemplary cartridge storing the flavouring agents according to the embodiments of the present disclosure. The flavouring agents are filled in one or more cartridges 1202 stored in the slots 1004 provided at the cartridge storage compartment 404. The exact shape and size of the cartridge 1202 may vary accordingly without any change from its technical aspects.

The flavouring agents disclosed herein may include a wide variety of ingredients generally used in cooking such as condiments, spices, sauces, oils, flavouring solutions, flavouring chemicals, taste enhancers, natural and/or artificial flavouring substances, syrups, emulsifiers, raising agents, stabilizing agents, and the like. The flavouring agents may be stored in solid, powdered, semi-solid, or liquid form as understood by a person skilled in the art. The plurality of flavour injectors comprise nozzles for spraying the flavouring agents onto contents placed inside the body of the cooking apparatus. Flavouring agents may be sprayed in different pressure at different intervals and temperatures by the flavor injections using a set of nozzles. Contents placed in the oven such as meat, vegetables, bread, or any other cooking base is injected with the flavouring agent by the flavour injectors depending upon the cooking mode which may include at least one of a microwave mode, a convection mode, or a grilling mode.

The magnetrons used in the apparatus may generate microwaves as understood by a person skilled in the art. The generated waves may be guided using the wave guides for cooking. In convection mode, fans may be used to dissipate heat generated by the heating elements across the cooking chamber.

User inputs may be received via a plurality of buttons provided on the body of the apparatus or via a touchscreen display provided on the body of the apparatus. Alternatively, inputs and instructions may also be received from connected electronic devices. Connected electronic device may include at least one of: a laptop computer, a desktop computer, a tablet, a smartphone, a smart wearable device, and the like. The cooking apparatus may be powered by connecting the apparatus directly to an Alternating Current (AC) or Direct Current (DC) power source. Other components of the apparatus include a turn table, a turn table support, a thermostat, transformers, capacitor, diodes, fuse, lights, one or more support grills, oven racks, cooling fans, a display, a touch panel, connecting tubes, valve actuators, fluid pumps, a cartridge presence detector, printed circuit boards, and the like.

The flavour injectors connected to the cartridges may further be configured to move across one of the sides of the cooking apparatus during the cooking process. Motors may be used for managing the movement of these components to provide uniform flavouring. In one example, servo motors may be used for controlling the speed, direction and other related aspects of the moving nozzles.

The apparatus communicated with the connected electronic device to provide a variety of notifications and services. The apparatus may notify uses of the status of cooking via the electronic device. It may alert the user upon completion of cooking. It may alert the user regarding the status of the ingredients present in the cartridges. Furthermore, to may allow users to directly purchase new cartridges, recipes and other related cooking essentials by connecting to online stores. The apparatus along with the connected electronic device may also monitor the calorie content of the recipes prepared by the apparatus. Since exact quantities of ingredients used are known to the apparatus, it may be easier for the apparatus and the connected electronic device to calculate the total amount of calories present in each dish cooked by the apparatus. This allows users to keep track of their calorie intake and modify the recipe to match their calorie requirements and/or targets.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications, and changes may be made without departing from the spirit of the present solution. All the features disclosed in this specification (including any accompanying claims, abstract, and drawings), and all of the steps of any method or process so disclosed, may be combined in any combination, except combinations where at least some of such features or steps are mutually exclusive.

The terms “include,” “have,” and variations thereof, as used herein, have the same meaning as the term “comprise” or an appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A cooking apparatus, comprising:
a body;
one or more cartridges inserted into the body via one or more slots provided in the body, wherein the one or more cartridges comprise flavouring agents;
a cooking chamber disposed within the body, wherein the cooking chamber is connected to the one or more cartridges via a plurality of valves; and
a microcontroller disposed within the body programmed to perform the steps of:
receiving input from a user specifying a recipe to be cooked by the cooking apparatus;
determining a cooking pattern including cooking temperature, cooking mode, and cooking time based on the recipe to be cooked;
determining ratios of flavouring agents that are to be added from each of the one or more cartridges based on the recipe to be cooked;
determining quantities of flavouring agents that are to be added from each of the one or more cartridges based on the determined ratios of flavouring agents;
determining flavour agent dispensing intervals based on the recipe to be cooked and the determined cooking pattern;
dispensing the determined quantities of flavouring agents via a plurality of flavour injectors based on the flavour agent dispensing intervals, wherein the plurality of flavour injectors are connected to the plurality of valves; and
activating heating component disposed within the body of the cooking apparatus based on the determined cooking pattern.

2. The cooking apparatus of claim 1, wherein the flavouring agents include ingredients used in cooking including condiments, spices, sauces, oils, and flavouring solutions.

3. The cooking apparatus of claim 1, wherein the plurality of valves are controlled by the microcontroller via a plurality of valve actuators.

4. The cooking apparatus of claim 1, wherein the plurality of flavour injectors comprise nozzles for spraying the flavouring agents onto contents placed inside the body of the cooking apparatus.

5. The cooking apparatus of claim 1, wherein the cooking mode includes microwave mode, convection mode, and grilling mode.

6. The cooking apparatus of claim 1, wherein the heating components include magnetrons associated with wave guides and fans associated with heating elements.

7. The cooking apparatus of claim 1, wherein the user inputs are received via a plurality of buttons provided on the body of the apparatus.

8. The cooking apparatus of claim 1, wherein the user inputs are received via a touchscreen display provided on the body of the apparatus.

9. The cooking apparatus of claim 1, wherein the apparatus further comprises a communication module capable of sending and receiving data via wired or wireless transmission mechanisms.

10. The cooking apparatus of claim 9, wherein the user inputs are received via a user interface provided in an electronic device and the received inputs are transferred from the electronic device to the apparatus using the communication module.

11. The cooking apparatus of claim 10, wherein the electronic device includes at least one of: a laptop computer, a desktop computer, a tablet, a smartphone, and a smart wearable device.

12. The cooking apparatus of claim 1, wherein the apparatus is powered by connecting the apparatus directly to an Alternating Current (AC) or Direct Current (DC) power source.

14. The cooking apparatus of claim 1, wherein the body further comprises a turn table, a turn table support, a thermostat, transformers, capacitor, diodes, fuse, lights, one or more support grills, oven racks, cooling fans, a display, a touch panel, connecting tubes, valve actuators, fluid pumps, a cartridge presence detector, and printed circuit boards.
